(19) United States
(12) Patent Application Publication
(10) Pub. No.: US 2008/0198894 A1
(43) Pub. Date: Aug. 21, 2008

(54) Method For Regulating the Melting Process in an Electric-Arc Furnace

(76) Inventor: Thomas Matschullat, Eckental (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/916,211

(22) PCT Filed: May 30, 2006
(86) PCT No.: PCT/EP2006/062744

§ 371 Date: Nov. 30, 2007

(30) Foreign Application Priority Data
Jun. 10, 2005 (DE) 10 2005 026893.5

(51) Int. Cl. H05B 7/148; G06G 7/56

(52) U.S. Cl. 373/104; 703/6; 700/209

(57) ABSTRACT

In a method for regulating the melting process in an electric-arc furnace (1) which contains a furnace charge (4) containing the following temporally successive principal phases: melt, slag, solid, the proportion and temperature of at least the melt phase are calculated by a model (3). The model (3) embodied as a multispatial model for the different phases of the furnace charge (4), enables to include the physical effect according to which the temperature (TM) of the overheated melt decreases shortly before the complete dissolution of the remainder of the solid, in spite of the energy supply. Moreover, this effect is counteracted in that the electrical and/or chemical energy input is temporarily increased in a targeted manner. The modelling enables the real temperature profile (TM) of the melt to be represented, thus also improving the predictability of the tapping temperature. The number of temperature measurements required is, thus, reduced.

### CROSS-REFERENCE TO RELATED APPLICATIONS

This application is a U.S. national stage application of International Application No. PCT/EP2006/062744 filed May 30, 2006, which designates the United States of America, and claims priority to German application number 10 2005 026 893.5 filed Jun. 10, 2005, the contents of which are hereby incorporated by reference in their entirety.

### TECHNICAL FIELD

The invention relates to a method for regulating the melting process in an electric-arc furnace by means of a model, the electric-arc furnace containing a furnace charge, which at least temporarily comprises the phases melt, slag and solid.

### BACKGROUND

An electric-arc furnace is used to produce steel by melting a starting material. Scrap and/or iron, preferably directly reduced iron, is used as the starting material. The starting material is melted through the input of energy. The furnace charge present in the electric-arc furnace comprises three essential phases during the melting process: melt, slag and solid. These phases may be present simultaneously, but do not have to be.

Conventionally, the melting process is concluded by the process of “tapping”, when the average furnace temperature has reached a predetermined tapping temperature.

### SUMMARY

According to an embodiment, a method for regulating the melting process in an electric-arc furnace, the electric-arc furnace containing a furnace charge which at least temporarily comprises the phases melt, slag and solid, may comprise the steps of: calculating the proportion and temperature of at least the melt phase by means of a model, determining a drop in the temperature of the melt by means of the model, wherein said temperature drop taking place, when the melting process is operated in a known manner, when a major part of the solid is already molten, and counteracting the temperature drop by a purposeful increase in energy input.

According to a further embodiment, the proportion and temperature of the slag and/or solid phases can also be calculated. According to a further embodiment, the temperature of the melt, slag and/or solid phases can be calculated predictively. According to a further embodiment, the time and quantity of the increase in energy input can be determined by means of the model. According to a further embodiment, at least one tapping time can be calculated in advance by means of the model.

According to another embodiment, a computer program product comprises a computer readable medium storing program code which when executed on a computing device is suitable for carrying out the steps of a method for regulating the melting process in an electric-arc furnace, the electric-arc furnace containing a furnace charge which at least temporarily comprises the phases melt, slag and solid, the method comprising the steps of: calculating the proportion and temperature of at least the melt phase by means of a model, determining a drop in the temperature of the melt by means of the model, wherein said temperature drop taking place, when the melting process is operated in a known manner, when a major part of the solid is already molten, and counteracting the temperature drop by a purposeful increase in energy input.

According to another embodiment, a computing device for controlling and/or regulating an electric-arc furnace containing a furnace charge which at least temporarily comprises the phases melt, slag and solid, the computing device being programmable to calculate the proportion and temperature of at least the melt phase by means of a model, to determine a drop in the temperature of the melt by means of the model, wherein said temperature drop taking place, when the melting process is operated in a known manner, when a major part of the solid is already molten, and to counteract the temperature drop by a purposeful increase in energy input.

### BRIEF DESCRIPTION OF THE DRAWINGS

Further advantages and details of the invention are explained below by way of example with reference to the drawings, in which:

FIG. 1 is a schematic representation of an electric-arc furnace with a computing device for control and/or regulation thereof,

FIG. 2 shows the effect of the drop in temperature of the melt,

FIG. 3 shows the improved actual temperature profile of the melt in comparison with the actual temperature profile of the melt in known methods,

FIG. 4 is a flow chart of the regulation method according to an embodiment.

### DETAILED DESCRIPTION

According to an embodiment, the temperature of the melt phase is calculated by means of a preferably thermodynamic model. In this way, significantly more accurate regulation of the melting process is possible than with a method which merely takes account of the measured and/or calculated average furnace temperature for regulation.

Advantageously, according to an embodiment, the proportion and respective temperature of the slag and/or solid phases may also be calculated.

According to an embodiment, the method may be further improved by predictive calculation of the temperature of the melt, slag and/or solid phases.

Advantageously, according to an embodiment, a drop in the temperature of the melt may be determined by means of the model, this taking place in the course of the melting process when a major part of the solid is already molten. This temperature drop takes place conventionally shortly before complete melting of the remaining solid despite ongoing energy input. Such a temperature drop was not previously recognized. If it was detected at all during measurements, the corresponding measured values were classified as measurement errors. In known methods for regulating the melting process, which take account of the average furnace temperature, the average furnace temperature corresponding to a mean value of the temperature of all phases in the furnace, this temperature drop was not taken into account.

By determining and taking account of said temperature drop when regulating the melting process, the tapping temperature can be better predicted and a representation of the temperature profile of the furnace charge, in particular melt, is obtainable which is a much closer reflection of reality.

Advantageously, the temperature drop may be counteracted by a purposeful increase in energy input. In this way, the tapping temperature is reached sooner. The process time is reduced and thus higher productivity is achieved.

Advantageously, the time and quantity of the increased energy input may be determined by means of the model.

Advantageously, at least one tapping time is calculated in advance by means of the model.

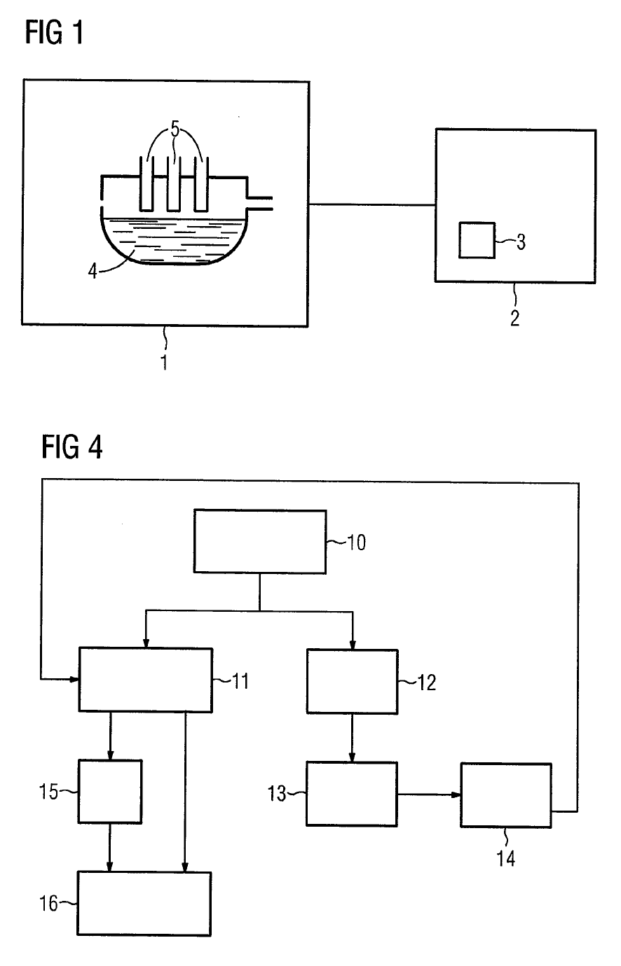

FIG. 1 is a schematic representation of an electric-arc furnace 1, which is coupled to a computing device 2 for controlling and/or regulating the electric-arc furnace 1. The computing device 2 is programmed with a computer program product and comprises a model 3 of the electric-arc furnace 1 or of the melting process which takes place in the electric-arc furnace 1.

The electric-arc furnace 1 contains a furnace charge 4. At the start of the melting process the furnace charge 4 consists at least to a very great extent of solid material, preferably of scrap and/or iron, in particular directly reduced iron, which is melted over the course of the melting process through the input of energy. Over the course of the melting process, the furnace charge 4 has three essential phases: melt, slag and solid. These various phases may be present simultaneously, but do not have to be. The energy is input into the furnace charge 4 preferably via the electrodes 5 in the form of electrical energy. An “arc”, not shown in any greater detail in the drawing, then forms at the electrodes 5. The energy input into the furnace charge 4 may also be of the fossil and/or chemical type. The energy input into the furnace charge 4 leads to heating and melting of the furnace charge 4.

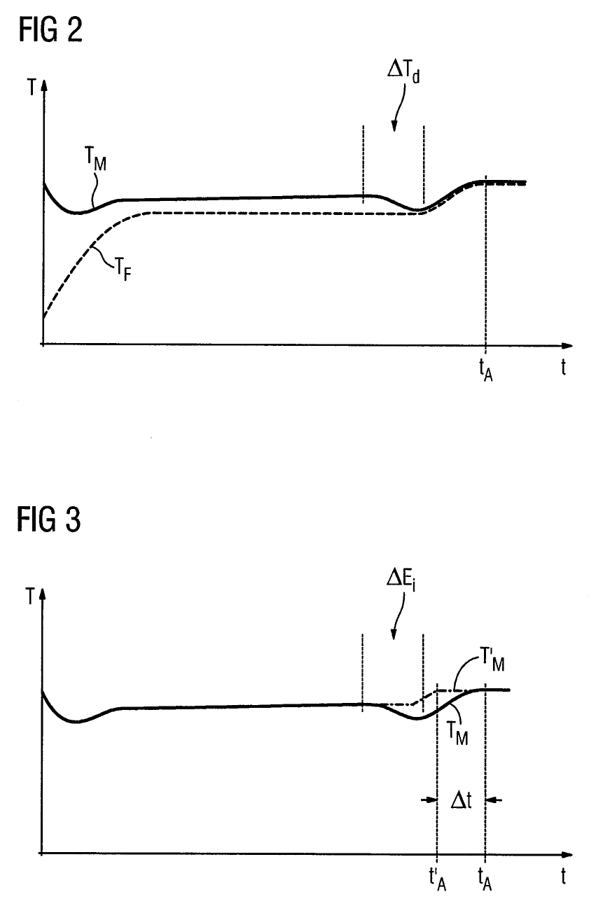

FIG. 2 is a representation of the temperature T over time t. In particular, FIG. 2 shows the profile of the temperature T_{M} of the melt and the profile of the average furnace temperature T_{F}. Using the model 3, the profile of the temperature T_{M} of the various phases of the furnace charge 4 may be calculated. As a result of calculation according to an embodiment of the profile of the temperature T_{M} of the melt by means of the model 3, the temperature drop shown in the drawing at ΔT_{d} is determined for the first time. This temperature drop ΔT_{d} is not detected or at least not taken into account in known methods, which merely measure and/or calculate the average furnace temperature T_{F}. The profiles shown of the temperatures T_{M} and T_{F} correspond to the actual temperature profiles for known methods, which have not previously been determined in this way or at least not taken into account when regulating and/or controlling the melting process or the electric-arc furnace 1. In known methods for regulating the melting process in an electric-arc furnace 1, the tapping time t_{A} is obtained on the basis of the average furnace temperature T_{F}.

FIG. 3 also shows the profile of the temperature T_{M} of the melt. If the temperature drop ΔT_{d} (see FIG. 2) arising when the melting process is operated in the known manner is counteracted by a purposeful increase in the energy input ΔEᵢ, an improved profile is obtained for the temperature T′_{M} of the melt, in which the melt reaches the temperature necessary for tapping at an earlier tapping time t′_{A}. By counteracting the hitherto undetected temperature drop ΔT_{d} in accordance with various embodiments towards the end of the melting process by increasing the energy input ΔEᵢ, a tapping time t′_{A} may be achieved which is distinctly earlier and thus better than the tapping time t_{A} of known methods. The short-term increase in energy input ΔEᵢ gives rise to a time saving Δt.

The method according to an embodiment for regulating the melting process in an electric-arc furnace 1 preferably proceeds as illustrated schematically in FIG. 4:

Calculation 10 of the process status takes place continuously, the temperatures of the various phase proportions, such as for example of the melt and optionally also the slag and/or the solid, being calculated by means of the model 3. Other variables characteristic of the process status, in particular also the proportions of the respective phases, may also be calculated. The current process status is displayed visually 11 online, i.e. in real time and preferably continuously.

Using the model 3, the time at which a temperature drop ΔT_{d} is to be expected when the electric-arc furnace 1 is operated in the known manner is determined predictively 12. On the basis of this time, the time and quantity of the increased energy input ΔEᵢ are determined 13. Adjustment 14 accordingly takes place of process parameters, such as transformer tapping, position of the electrodes, energy input via the electrodes, and/or chemical energy input into the electric-arc furnace 1. The resultant influencing of the melting process is taken into account in the visual display 11 of the process status. On the basis of the calculations performed using the model 3, tapping 16 of the melt takes place at the earlier tapping time t′_{A} according to an embodiment.

Advantageously, the earlier tapping time t′_{A} and/or the tapping time t_{A} in the event of the electric-arc furnace 1 being operated in the known manner is/are calculated in advance by means of the model 3. To determine the tapping time(s) t_{A} or t′_{A}, detection 15 of measured values may also advantageously take place, which may be fed to the model 3.

In summary:

In a method for regulating the melting process in an electric-arc furnace 1, the electric-arc furnace 1 containing a furnace charge 4 which at least temporarily comprises the following essential phases: melt, slag, solid, the proportion and temperature of at least the melt phase is calculated by means of the model 3. By means of the thermodynamic model 3, which takes the form of a multi-space model for the various phases of the furnace charge 4, it is possible for the first time to take account of the physical effect that the temperature T_{M} of the superheated melt falls shortly before complete dissolution of the residues of the solid despite energy input. In order further to optimize the melting process, this effect is counteracted in that the electrical and/or chemical energy input into the electric-arc furnace 1 is increased purposefully for a short time, e.g. actually during this temperature drop phase. The modeling according to an embodiment allows the real temperature profile T_{M} of the melt to be represented for the first time as it arises during a melt process in an electric-arc furnace operated in the conventional manner without additional increase in energy input ΔEᵢ. The predictability of the tapping temperature is improved according to an embodiment. As a result of the purposeful increase in energy input ΔEᵢ, the duration of the melting process is shortened substantially and thus productivity is increased. Total energy consumption is reduced in particular due to the shorter process duration. The number of necessary temperature measurements is reduced.

What is claimed is:

1. A method for regulating the melting process in an electric-arc furnace, the electric-arc furnace containing a furnace charge which at least temporarily comprises the phases melt, slag and solid, the method comprising the steps of:
calculating the proportion and temperature of at least the melt phase by means of a model,
determining a drop in the temperature of the melt by means of the model, wherein said temperature drop taking place, when the melting process is operated in a known manner, when a major part of the solid is already molten, and
counteracting the temperature drop by a purposeful increase in energy input.

2. The method according to claim 1,
wherein the proportion and temperature of the slag and/or solid phases are also calculated.

3. The method according to claim 1,
wherein the temperature of the melt, slag and/or solid phases is calculated predictively.

4. The method according to claim 1,
wherein the time and quantity of the increase in energy input are determined by means of the model.

5. The method according to claim 1,
wherein at least one tapping time is calculated in advance by means of the model.

6. A computer program product comprising a computer readable medium storing program code which when executed on a computing device is suitable for carrying out the steps of a method for regulating the melting process in an electric-arc furnace, the electric-arc furnace containing a furnace charge which at least temporarily comprises the phases melt, slag and solid, the method comprising the steps of:
calculating the proportion and temperature of at least the melt phase by means of a model,
determining a drop in the temperature of the melt by means of the model, wherein said temperature drop taking place, when the melting process is operated in a known manner, when a major part of the solid is already molten, and
counteracting the temperature drop by a purposeful increase in energy input.

7. A computing device for controlling and/or regulating an electric-arc furnace containing a furnace charge which at least temporarily comprises the phases melt, slag and solid, the computing device being programmable to:
calculate the proportion and temperature of at least the melt phase by means of a model,
determine a drop in the temperature of the melt by means of the model, wherein said temperature drop taking place, when the melting process is operated in a known manner, when a major part of the solid is already molten, and
counteract the temperature drop by a purposeful increase in energy input.

8. The computer program product according to claim 6,
wherein the proportion and temperature of the slag and/or solid phases are also calculated.

9. The computer program product according to claim 6,
wherein the temperature of the melt, slag and/or solid phases is calculated predictively.

10. The computer program product according to claim 6,
wherein the time and quantity of the increase in energy input are determined by means of the model.

11. The computer program product according to claim 6,
wherein at least one tapping time is calculated in advance by means of the model.

12. The computing device according to claim 7,
wherein the proportion and temperature of the slag and/or solid phases are also calculated.

13. The computing device according to claim 7,
wherein the temperature of the melt, slag and/or solid phases is calculated predictively.

14. The computing device according to claim 7,
wherein the time and quantity of the increase in energy input are determined by means of the model.

15. The computing device according to claim 7,
wherein at least one tapping time is calculated in advance by means of the model.
